(19) United States
(12) Patent Application Publication
(10) Pub. No.: US 2026/0135576 A1
(43) Pub. Date: May 14, 2026

(54) RANDOM SIGNAL GENERATOR

(71) Applicant: Rockwell Collins, Inc., Cedar Rapids, IA (US)

(72) Inventors: Benjamin PEIFFER, Cedar Rapids, IA (US); Sierra SOURASINTH, Cedar Rapids, IA (US)

(73) Assignee: Rockwell Collins, Inc., Cedar Rapids, IA (US)

(21) Appl. No.: 18/941,431

(22) Filed: Nov. 8, 2024

(51) Int. Cl. H04B 1/02; G06F 7/58

(52) U.S. Cl. CPC H04B 1/02; G06F 7/588

(57) ABSTRACT

A random radio frequency (RF) signal generator includes a true random number generator (TRNG) that generates an output seed used by a digital signal generator to perform random operations to generate a random RF signal using an RF front-end. The digital signal generator includes a seed slicer to slice the output seed into slices of random bits. A pseudo-random number generator (PNG) controller uses slices to select a PNG of a bank of PNGs to generate random output using a PNG select multiplexer for a first number of clock counts. A signal processing controller uses slices to adjust a digital signal generate from the random output. A hardware controller uses slices at apply a hardware adjustment to a hardware component within the RF front-end to further vary the digital signal to generate the random RF signal.

### FIELD OF THE INVENTION

The subject matter disclosed herein relates to a random signal generator to generate a radio frequency (RF) signal. In particular, the subject matter disclosed herein relates to a random signal generator that uses a random number generator as a seed to control the random signal generation.

### BACKGROUND OF THE INVENTION

Known random signal generators use pseudo-random number generators (PNGs) that are predictable over long observation baselines. For example, an application of advanced, artificial intelligence (AI) or machine learning (ML) based systems may infer the PNG algorithm and seed that is being used by the signal generator.

It may be appreciated that a need exists for a random signal generator that is not easily predictable by AI or ML devices.

### SUMMARY OF THE INVENTION

The present disclosure is directed, in a first aspect, to a random radio frequency (RF) signal generator system. The random RF signal generator system includes a true random number generator (TRNG) configured to generate an output seed. The random RF signal generator system also includes a digital signal generator connected to the TRNG. The digital signal generator includes a seed slicer to receive the output seed. The seed slicer slices the output seed to generate a plurality of slices of random bits. The digital signal generator also includes a pseudo-random number generator (PNG) controller to receive a first set of slices of the plurality of slices from the seed slicer. The PNG controller controls a bank of PNGs. The digital signal generator also includes a PNG select multiplexer coupled to the PNG controller and the bank of PNGs. Each PNG of the bank of PNGs produces a random output based on a first slice of bits of the first set of slices. The PNG select multiplexer is configured to transmit the random output from a select PNG of the bank of PNGs selected using a second slice of bits of the first set of slices. The PNG controller reinitializes the bank of PNGs and the PNG select multiplexer based on a third slice of bits of the first set of slices. The random RF signal generator system also includes an RF front-end to generate a random RF signal based on the random output from the select PNG.

In yet another embodiment, the present disclosure is directed to a random radio frequency (RF) signal generator system. The random RF signal generator system includes a true random number generator (TRNG) configured to generate an output seed. The random RF signal generator system also includes a digital signal generator connected to the TRNG to receive the output seed. The digital signal generator includes a seed slicer configured to slice the output seed into a first set of slices of random bits from the output seed, a second set of slices of random bits from the output seed, and a third set of slices of random bits from the output seed. The digital signal generator also includes a pseudo-random number generator (PNG) controller coupled to a bank of PNGs and a PNG select multiplexer. The PNG controller is configured to select a select PNG of the bank of PNGs to generate random output using the PNG select multiplexer for a first number of clock counts based on the first set of slices from the seed slicer. The digital signal generator also includes a signal processing controller coupled to a processing module and a filter to generate a digital signal from the random output. The signal processing controller is configured to apply a phase adjustment or an amplitude adjustment to the digital signal for a second number of clock counts based on the second set of slices from the seed slicer. The digital signal generator also includes a hardware controller coupled to at least one hardware component to generate a random signal from the digital signal. The hardware controller is configured to apply at least one hardware adjustment to the at least one hardware component for a third number of clock counts based on the third set of slices from the seed slicer. The random RF signal generator system also includes an RF front-end having the at least one hardware component configured to generate a random RF signal from the digital signal according to the least one hardware adjustment.

In yet another embodiment, the present disclosure is directed to a method for generating a random radio frequency (RF) signal using a random RF signal generator. The method includes generating an output seed of random bits from a true random number generator (TRNG). The method includes slicing the output seed into a first set of slices of random bits, a second set of slices of random bits, and a third set of slices of random bits using a seed slicer. The method also includes generating a random output using a select pseudo-random number generator (PNG) of a bank of PNGs coupled to a PNG controller using a PNG select multiplexer based on the first set of slices from the seed slicer. The method also includes generating a digital signal from the random output from the select PNG. The method also includes adjusting the digital signal using a phase adjustment or an amplitude adjustment from a signal processing controller based on the second set of slices from the seed slicer. The method also includes applying at least one hardware adjustment to the digital signal using at least one hardware component. The at least one hardware adjustment is applied using a hardware controller based on the third set of slices from the seed slicer. The method also includes generating the random RF signal based on the digital signal using an RF front-end having the at least one hardware component.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a block diagram of a random signal generator system according to the disclosed embodiments.

FIG. 2 illustrates a graph of a signal along an amplitude axis and a frequency axis according to the disclosed embodiments.

FIG. 3 illustrates a flowchart for generating a random RF signal using the random signal generator system according to the disclosed embodiments.

FIG. 4 illustrates a flow diagram for operating a PNG controller according to the disclosed embodiments.

FIG. 5 illustrates a flow diagram for operating signal processing controller according to the disclosed embodiments.

FIG. 6 illustrates a flow diagram for operating a hardware controller according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

The present disclosure is directed to a system for generating a random signal that is not readily predictable by AI or ML devices. This outcome is achieved by randomly varying not only the generated symbols, but all other aspects of the generated signal as well. A true random number generator (TRNG) may be the source of all system variations ensuring that no repeatable or predictable patterns are produced.

The disclosed embodiments may use a true random number generator (TRNG) as a seed to control random signal generation. The disclosed embodiments may be able to randomly switch between many different pseudo-random number generators. Additionally, the disclosed process may be repeated with various signal processing characteristics. A hardware controller may provide more random variation to hardware characteristics within the system.

Known random signal generators may use one or very few pseudo-random number generators. These generators use a seed that may be easily predicted by modern AI/ML software. The disclosed embodiments avoid this issued by re-seeding or switching algorithms at random intervals to reduce the probability of prediction.

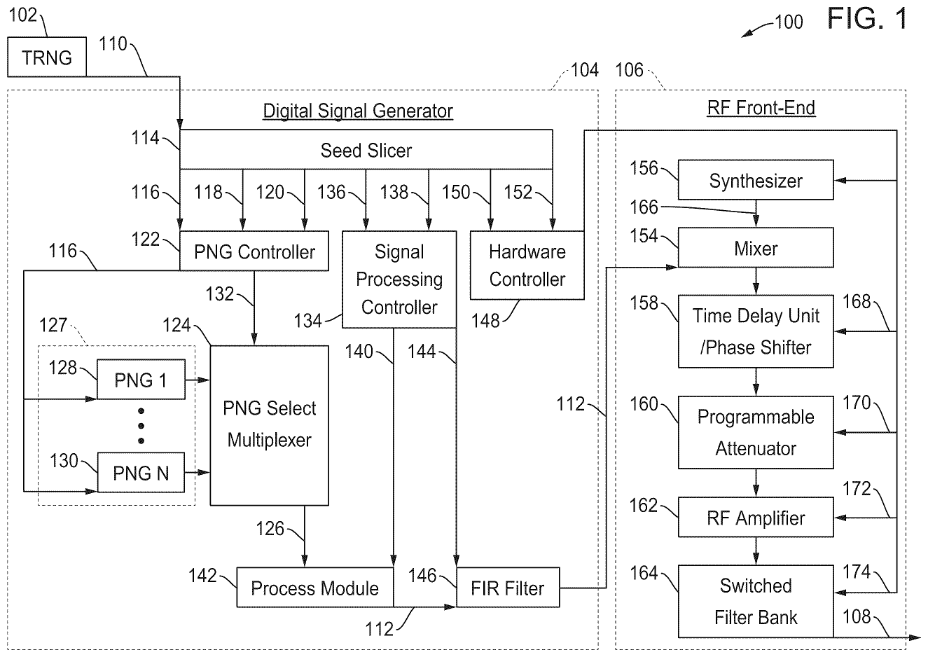

FIG. 1 depicts a block diagram of a random signal generator system 100 according to the disclosed embodiments. System 100 may be comprised of three components that are disclosed in greater detail below. True random number generator (TRNG) 102 provides an output seed 110 to digital signal generator 104 as input. Digital signal generator 104 generates digital signal 112 that is provided to radio frequency (RF) front end 106. RF front end 106 takes digital signal 112 plus other data provided by digital signal generator 104 to generate random RF signal 108. This feature may reduce the impact of outside interference by mixing the random input with a series of counters.

TRNG 102 may generate numbers in a manner that is fundamentally unpredictable and non-deterministic, as opposed to pseudo-random number generators (PNGs). TRNG 102 may rely on a physical process to generate randomness. For example, TRNG 102 may use electronic noise in an electronic component that is captured and digitized to produce random numbers. Any analog signal may be converted into a digital form. The digital form may be post-processed to ensure the generated numbers are uniformly random and not biased. TRNG 102 outputs seed 110 that is a sequence of numbers such that each number is unpredictable and should not follow any deterministic pattern. In some embodiments, TRNG 102 may be enabled by a microcontroller configured to execute the processes disclosed above.

Seed slicer 114 of digital signal generator 104 receives output seed 110 from TRNG 102. Output seed 110 may be transferred at a rate of many megabits per second from TRNG 102. In one non-limiting example, the rate may be 32 megabits per second. Seed slicer 114 slices output seed 110 into a plurality of slices. Each slice is provided to a series of controllers that are used to permute the behavior of digital signal generator 104.

In some embodiments, output seed 110 is not enough to provide random numbers for digital signal generator 104. TRNG 102 may not be able to generate sequences fast enough. For example, TRNG 102 may be able to generate millions of random bits per second but system 100 may need billions of bits per second. Thus, the output of TRNG 102 is used as seeding in digital signal generator 104 in control other components in generating random signal 108. Seeds are used to control a plurality of pseudo-random number generators (PNGs). Different processers in the other controllers are varied to remove patterns and remove any consistencies.

Seed slicer 114 slices output seed 110. In some embodiments, seed slicer 114 may slice output seeds to generate 100 bits per second to use as “seeds” for the other controllers in digital signal generator 104. Seed slicer 114 provides next seed 116 to PNG controller 122. Next seed 116 is a slice of output seed 110. Digital signal generator 104 includes a bank of N PNG blocks and a PNG select multiplexer 124 that connects an active PNG block to provide output 126. PNG controller 122 randomly selects a PNG, which remains active for a random time interval. PNG controller 122 may use a slice of output seed 110 to initialize all PNGs are startup and then reinitializes all unused PNGs each time the active selection is changed.

As disclosed above, digital signal generator 104 includes a bank, or plurality, 127 of PNG blocks, or PNGs. Rather than use TRNG 102 directly, system 100 uses a PNG from bank 127 of PNGs to generate random symbols as output 126. This feature enables faster symbol rates to be achieved. In some instances, these rates may be 1000 times faster than just using output seed 110 to generate random signal 108. Sequences generated by PNGs may not be truly random as the output may be predicted if the PNG algorithm and seed are known. This determinism allows for AI/ML systems to classify which PNG algorithm and seed are being used after many observations have been made. Thus, the disclosed embodiments implement randomly switching between various PNGs and frequently reseeding the PNGs.

In some embodiments, next seed 116 is provided to PNG controller 122 from a slice of output seed 110 from TRNG 102. Next seed 116 may be 64 bits. Other slices of output seed 110 may be next PNG 118 and PNG dwell 120. An exemplary process to control of PNG controller 122 using these slices is disclosed below. Next seed 116 may be the next seed to provide to one of the PNGs in bank 127. Bank 127 may include any number of PNGs from first PNG 128 to Nth PNG 130. In some embodiments, the number of PNGs in bank 127 may be 8 or more. In alternate embodiments, the number of PNGs may be dozens.

PNG controller 122 provides next seed 116 to a PNG selected based on next PNG 118. Next PNG 118 is a slice of output seed 110 that may be further modified to indicate which PNG of bank 127 to select to receive next seed 116. For example, next PNG 118 may be used as an input to an equation to determine an N, or number, of the PNG to use in generating output 126. Each PNG may implement a different algorithm from generating the symbols for output 126. For example, one PNG may implement linear feedback shift register (LFSR) process to generate output while another PNG may implement a more complex algorithm like the Mersenne twister.

PNG controller 122 may solve for N in the provided equation to determine PNG selection 132. The PNGs may be seeded with next seed 116. Multiplexer 124 then selects the PNG of bank 127 based on PNG selection 132 to output for the rest of the digital signal generating process. Multiplexer 124 allows the output of the selected PNG to be provided as output 126 for a random period of time based on PNG dwell 120. One weakness of re-seeding is that it may be based on a fixed interval, so that an upcoming re-seed event may be predictable. The disclosed embodiments may vary the intervals between re-seeding to make it more difficult to recognize a timing pattern between each re-seeding.

PNG dwell 120 is a slice of output seed 110 that provides a count down for the selected PNG to provide output through multiplexer 124. PNG dwell 120 may be 24 bits and used by PNG controller 122 to determine when to grab additional bits from seed slicer 114 for next seed 116 and next PNG 118. According to the disclosed embodiments, a dwell is the number of clock ticks in the signal processing controller. This definition means that if the signal processor runs at a clock rate of 1 GHz, then the maximum dwell time generated in a 24 bit slice would represent a dwell of 16.7 ms. These numbers may vary based on specific decisions, such as faster or slower clock rates or large or smaller slice sizes. The period for each PNG dwell 120 relates to the use of random bits from the slice to identify a period that the PNG selected by next PNG 118 will be allowed to generate output 126. At the end of the period specified by PNG dwell 120, PNG controller 122 reinitializes the process again to make it difficult to recognize a timing pattern.

According to the disclosed embodiments, a random number is used as a seed for a randomly selected PNG from bank 127 of a plurality of different PNGs. PNG controller 122 receives next seed 116 to seed the randomly selected PNG. Multiplexer 124 allows the randomly selected PNG to output the symbols as output 126 to the next component of the random signal generating process. The period for the randomly selected PNG to provide output 126 also is random based on a slice of bits from seed slicer 114, or PNG dwell 120. At the end of the period specified by PNG dwell 120, PNG controller 122 reinitializes by receiving new slices of bits to restart the generation of output 126 using multiplexer 124.

Digital signal generator 104 also includes signal processing controller 134. Digital signal generator 104 may vary aspects of the signal processing chain at random intervals. For example, signal processing controller 134 may switch between filters to vary the signal of output 126. The amplitude, filters, and other features of the signal also may be varied randomly by digital signal generator 104.

Next signal seed 136 is received from seed slicer 114 based on output seed 110. Seed slicer 114 takes a slice of bits from output seed 110, which are random, and provides them to signal processing controller 134. In some embodiments, next signal seed 136 may be 16,384 bits. Next signal seed 136 may be used for amplitude variation or filter variation of the signal generated by output 126 of multiplexer 124.

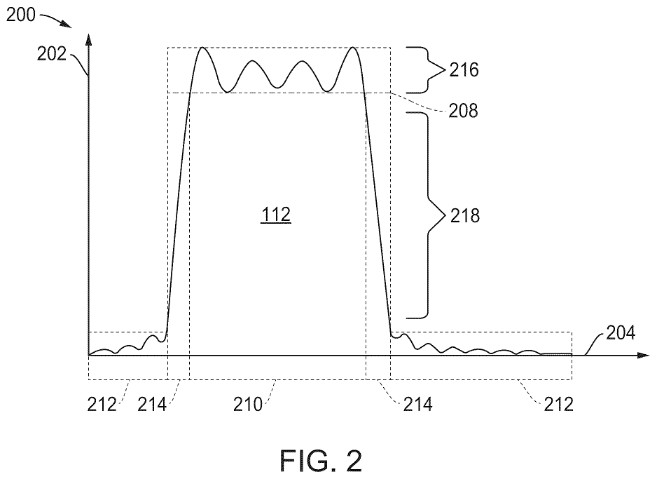

In some embodiments, an amplitude adjustment is applied to the signal by using a 16 bit portion of the seed and masking it to limit the amplitude adjustment to +/−3 dB from nominal. A phase adjustment also is determined using a 16 bit portion of the seed. The phase and amplitude adjustments are combined and applied to the transmitted sequence using a complex multiplier. A candidate filter may be selected using the random seed as input. Candidate filters may consist of FIR filters with various design methods and parameters. The taps on the selected FIR filters are perturbed slightly be multiplying with a masked portion of a seed. The 16 bit seed is masked to limit the tap adjustment to a maximum of 12%. These processes are disclosed in greater detail below, for example, in FIG. 2, which depicts a graph 200 of a signal 112 along an amplitude axis 202 and a frequency axis 204 according to the disclosed embodiments.

Signal 112 may be generated from output 126 using complex multiplication operations in processing module 142. Signal processing controller 134 provides phase/amplitude adjustment 140 to processing module 142. Processing module 142 receives output 126 and generates a signal 112 using digital signal processing techniques. Processing module 142 may include a function to adjust the signal amplitude before filtering. In some embodiments, processing module 142 may be a digital amplifier.

For amplitude variation, processing module 142 may vary an output level 208 of signal 112 by moving amplifier 162 in and out of compression, thereby exhibiting different linearity characteristics during different time intervals. Thus, the amplitude of signal 112 may be varied based on phase/amplitude adjustment 140. In some embodiments, the amplitude may be varied between 0.9 or 1.1 of output level 208 to provide a non-linear signal. The random use of the amplifiers may vary signal 112.

Signal processing controller 134 also may apply filter variation to signal 112. Phase/amplitude adjustment 140 may vary the filter type and design criteria of the filters to cause the characteristics of signal 112 to vary. For example, the bandwidth of signal 112 may randomly varied by changing passband 210 and stopband 212 of the applicable filter 256. Transition bands 214 also may be varied according to phase/amplitude adjustment 140.

Passband ripple 216 also may be varied to generate more distortion of signal 112. As shown in FIG. 2A, the amplitude of passband ripple 216 may change within passband 210. Stopband attenuation 218 also may be varied within a filter 256. Stopband attenuation 218 may refer to how effect the filter attenuates or reduces the amplitude of signal 112 within the stopband, or the frequency range where the filter is intended to block or significantly attenuate signal components.

The variation of these parameters of signal 112 will impact the filter output from one type to the next. This feature makes it challenging to recognize if a specific frequency band is being targeted. Signal processing controller 134 may use next signal seed 136 to determine which amplifier or filter to use in generating signal 112. Signal 112 is passed to FIR filter 146, where further variations may be applied.

FIR filter 146 may apply filter tap variation. The feature of varying the filter taps from the ideal values may degrade filter performance. This degradation may result in variations in cutoff frequency, passband ripple, and the like. Signal processing controller provides filter taps 144 that may be generated using next signal seed 136. FIR filter 146 applies filter taps 144. FIR filter 146 is a finite impulse response (FIR) filter. It may be a digital filter used to manipulate or transform signal 112 while having a finite duration impulse response.

Signal processing controller 134 also receives signal dwell 138 from seed slicer 114. Signal dwell 138 may be 24 bits. Signal dwell 138 may act like PNG dwell 120 as disclosed above. Signal processing controller 134 may count down from the random value provided by signal dwell 138. When the period defined by signal dwell 138 is done, then signal processing controller may reinitialize phase/amplitude adjustment 140 to switch the amplifiers and filter parameters being used to modify signal 112. It also may generate a new filter taps 144. Thus, the parameters of signal 112 are varied in a random manner and at random intervals.

The next set of variations may be hardware variations. Hardware controller 148 is used to implement the hardware variations. Digital signal generator 104 uses output seed 110 to randomly vary the hardware characteristics that are being exhibited by RF front-end 106. Hardware controller 148 receives next hardware seed 150 and HW dwell 152 from seed slicer 114 as slices of bits from output seed 110. Next hardware seed 150 may be 256 bits while HW dwell 152 may be 24 bits.

Hardware controller 148 differs somewhat from PNG controller 122 and signal processing controller 134 in that it controls components within RF front-end 106. RF front-end 106 may include mixer 154, synthesizer 156, time delay unit/phase shifter 158, programmable attenuator 160, RF amplifier 162, and switched filter bank 164. Hardware controller 148 provides inputs to these components to vary signal 112 further until RF signal 108 is output for use as a random signal.

Hardware variations implemented by hardware controller 148 may include amplifier bias variation. This type of variation may vary amplifier bias levels to cause signal edge times, compression points, and other observable characteristics to change. Other variations include delay/phase variation. This type of variation may vary the delay or phase of a transmitted signal using a time delay unit 158 or switched coarse delay line to cause the apparent source of signal 112 to move in space.

Hardware variations also may include an amplitude variation. The amplitude of a transmitted signal may be adjusted at various points along an RF signal chain using variable attenuators. Depending on the location and amount of amplitude variation, individual RF components may exhibit different levels of non-linearity.

Hardware controller 148 receives next hardware seed 150 as disclosed above. Next hardware seed 150 may include enough bits to seed the different variations provided by the commands sent to the various components in RF front-end 106. Signal 112 is received at mixer 154 from FIR filter 146. Mixer 154 may mix signal 112 with local oscillator (LO) signal 166 from synthesizer 156. Synthesizer 156 may act as a local oscillator to generate a stable, adjustable, and continuous electrical signal 166 at a specified frequency. LO signal 166 may be used by mixer 154 to change a frequency of signal 112. In some embodiments, hardware controller 148 may control the frequency of LO signal 166 in a random manner using next hardware seed 150.

Hardware controller 148 may send delay/phase signal 168 to time delay unit/phase shifter 158. The act of sending delay/phase signal 168 may be seeded by bits from next hardware seed 150. The random numbers from seed 150 may determine whether to instruct time delay unit/phase shifter 158 to vary the delay or phase of signal 112 according to signal 168. In some embodiments, hardware controller 148 may not send delay/phase signal 168 based on the values of the bits provided in next hardware seed 150.

Hardware controller 148 also may send attenuation signal 170 to programmable attenuator 160. Attenuation signal 170 may cause the amplitude of signal 112 to be adjusted using programmable attenuator 160. This attenuation may be done in addition to any adjustments made by signal processing controller 134. Programmable attenuator 160 may reduce the amplitude of signal 112 as controlled by attenuation signal 170. In some embodiments, attenuation signal 170 may be a signal provided by hardware controller 148 depending on the random number sequence allocated to this feature from next hardware seed 150.

Hardware controller 148 also may adjust drain voltage 172 of RF amplifier 162. Drain voltage 172 also may depend on next hardware seed 150. Bits from seed 150 may be used to determine whether to adjust drain voltage 172.

Hardware controller 148 also may send filter select signal 174 to switched filter bank 164. Filter select signal 174 may use bits from seed 150 to select a filter from filter bank 164 to apply to signal 112 to generate random RF signal 108. Filter bank 154 may be a group of filters, allowing one path to be used at any time. Filter bank 154 may implement a combination of switches and filters integrated into a single module. An input switch is followed by a filter for each channel of the switch, followed by an output switch.

Hardware controller 148 receives HW dwell 152, which acts as PNG dwell 120 and signal dwell 138 disclosed above. HW dwell 152 provides a random length from a slice of bits from seed slicer 114 for a period that hardware controller 148 controls the components in RF front-end 106. After the period of time defined by HW dwell 152 expires, hardware controller 148 may reinitialize by sending out new signals to the components of RF front-end 106. For example, hardware controller 148 may send attenuation signal 170 to programmable attenuator 160 for a period randomly defined by HW dwell 152. When a new HW dwell 152 is received, the random bits to determine whether to send attenuation signal 170 may indicate that a signal should be sent. Thus, hardware controller 148 reinitializes to not send an attenuation signal 170 to programmable attenuator 160. Signal 112 will change as a result.

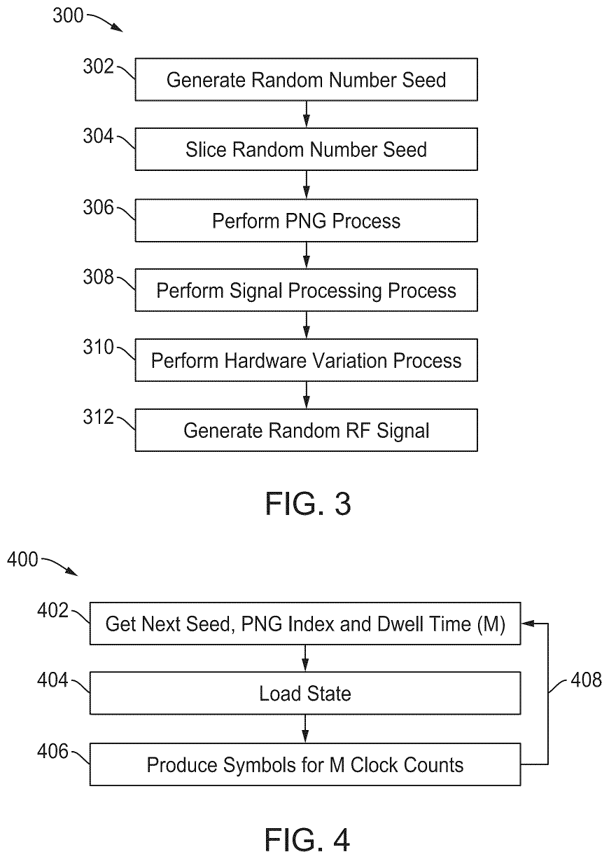

FIG. 3 depicts a flowchart 300 for generating a random RF signal 108 using random signal generator system 100 according to the disclosed embodiments. Flowchart 300 may refer to FIGS. 1-2B for illustrative purposes. Flowchart 300, however, is not limited by the embodiments disclosed by FIGS. 1-2B.

Step 302 executes by generating a random number seed using TRNG 102. As disclosed above, TRNG 102 generates output seed 110. Output seed 110 may include bits that are randomly generated based on some random activity, such as noise, detected by TRNG 102. Step 304 executes by slicing the random number seed into different slices of bits used to seed PNG controller 122, signal processing controller 134, and hardware controller 148. Instead of using output seed 110 directly to control components within digital signal generator 104 and RF front-end 106, the disclosed embodiments use the slices of output seed 110 to perform random actions that generate RF signal 108.

Step 306 executes by performing the PNG control process using PNG controller 122. PNG controller 122 may receive next seed 116, next PNG 118, and PNG dwell 120 as slices of bits from seed slicer 114. This process is disclosed in greater detail by FIG. 4, which depicts a flow diagram 400 for operating PNG controller 122 according to the disclosed embodiments. Flow diagram 400 also may refer to FIGS. 1-2B for illustrative purposes, but is not limited by the embodiments disclosed by FIGS. 1-2B.

Operation 402 executes by PNG controller 122 getting next seed 116, PNG index, or next PNG 118, and dwell time (M), or PNG dwell 120, from seed slicer 114. Seed slicer 114 may slice output seed 110 to provide the values for these items to PNG controller 122. As disclosed above, next seed 116 may be provided to a PNG of bank 127 of the PNGs connected to PNG controller 122. PNG index, shown as next PNG 118, may help PNG controller 122 to select the PNG to generate output 126 through multiplexer 124. Dwell time, as provided by PNG dwell 120, establishes the period of clock counts that PNG controller 122 to keep its PNG blocks in the current state.

Operation 404 executes by loading the state for operations into PNG controller 122. PNG index randomly identifies a PNG for bank 127 to be selected to generate output 126, as disclosed above. Based on the random value of next PNG 118, one of a number of PNGs is selected between first PNG 128 and Nth PNG 130. The identified PNG is provided to multiplexer 124, which opens the channel to the identified PNG to allow its output to flow therethrough. Multiplexer 124 does not allow output from the other PNGs to be transmitted. Next seed 116 may be provided to the selected PNG to generate the random output.

Operation 406 executes by producing symbols, or output, from the selected PNG through multiplexer 124 for M clock counts. The PNGs within the PNG bank 127 may produce bits. A group of 32 bits may be used to generate a symbol with bits 31:16 being set to the real part of a complex number and bits 15:0 being set to the imaginary part of the complex number. The complex number may be treated as a signed, fixed point number with 15 fractional bits. M may be determined by PNG dwell 120. In some embodiments, the 24 bits of the seed slice may be set to M. M is a random number in that PNG controller 122 is held in a current state for an ever changing amount of clock counts. At the end of M clock counts, operation 408 executes by returning to operation 402 to reinitialize PNG controller 122 using new slices of bits for next seed 116, next PNG 118, and PNG dwell 120.

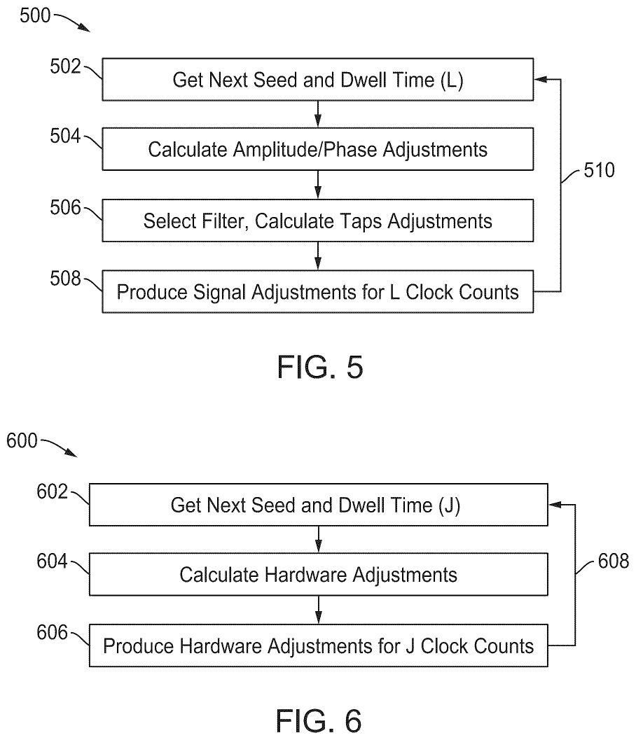

Returning to FIG. 3, step 308 executes by performing the signal processing control process using signal processing controller 134. Signal processing controller 134 may receive next signal seed 136 and signal dwell 138 as slices of bits from seed slicer 114. This process is disclosed in greater detail by FIG. 5, which depicts a flow diagram 500 for operating signal processing controller 134 according to the disclosed embodiments. Flow diagram 500 also may refer to FIGS. 1-2B for illustrative purposes, but is not limited by the embodiments disclosed by FIGS. 1-2B.

Operation 502 executes by signal processing controller 134 getting next signal seed 136 and dwell time (L), or signal dwell 138 from seed slicer 114. Seed slicer 114 may slice output seed 110 to provide the values for these items to signal processing controller 134. Operation 504 executes by calculating amplitude or phase adjustments 140 within signal processing controller 134. For example, the complex number built from the TRNG slice and then doing the complex multiply with the signal. The data may be used to provide a limited increase or decrease in amplitude by the desired percentage. Amplitude/phase adjustments 140 are provided to processing module 142 to modify output 126 from multiplexer 124 and generate signal 112. Amplitude/phase adjustments 140 randomly vary based on next signal seed 136 so that signal 112 also will vary randomly.

Operation 506 executes by selecting a filter and calculating taps adjustments to apply as filter taps 144 to FIR filter 146. The disclosed embodiments may include a bank of filters, or switched filter bank 164, that may have different characteristics. Filter taps 144 further vary signal 112 in a random manner using filter 146. The disclosed embodiments may randomly adjust which candidate filter is used along with some randomization of the taps of that filter. Step 508 executes by producing the signal adjustments, or symbols, for L clock counts as specified by dwell time based on signal dwell 138. L clock counts may differ from M clock counts such that output 126 may have different signal processing variations applied to the same output from multiplexer 124. Alternatively, different output 126 may have the same variations applied to them. At the end of L clock counts, operation 510 executes by returning to operation 502 to reinitialize signal processing controller 134 using new slices of bits for next signal seed 136 and signal dwell 138.

Returning to FIG. 3, step 310 executes by performing the hardware control process using hardware controller 148. Hardware controller 148 may receive next HW seed 150 and HW dwell 152 as slices of bits from seed slicer 114. This process is disclosed in greater detail by FIG. 6, which depicts a flow diagram 600 for operating hardware controller 148 according to the disclosed embodiments. Flow diagram 600 also may refer to FIGS. 1-2B for illustrative purposes, but is not limited by the embodiments disclosed by FIGS. 1-2B.

Operation 602 executes by hardware controller 148 getting next seed, or next HW seed 150, and dwell time (J), or HW dwell 152 from seed slicer 114. Seed slicer 114 may slice output seed 110 to provide the values for these items to hardware controller 148. Operation 604 executes by calculating hardware adjustments using next HW seed 150. Using the random values of the bits in next HW seed 150, hardware controller 148 determines whether to adjust various hardware components within RF front-end 106.

Operation 606 executes by producing the hardware adjustments for J clock counts as specified by dwell time based on HW dwell 152. J clock counts may differ from M and L clock counts such that signal 112 may have different hardware adjustment variations applied to the same signal from the signal processing variation process. Alternatively, different signals 112 may have the same hardware adjustment variations applied to them. At the end of J clock counts, operation 608 executes by returning to operation 602 to reinitialize hardware controller 148 using new slices of bits for next HW seed 150 and HW dwell 152.

Referring back to FIG. 3, step 312 executes by generating random RF signal 108 based on the random variations provided using PNG controller 122, signal processing controller 134, and hardware controller 148. Using millions of bits provided by output seed 110 from TRNG 102, digital signal generator 104 may help generate random signals that would require billions of bits just using a TRNG. The disclosed variations prevent the problems associated with known random signal generators.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A random radio frequency (RF) signal generator system comprising:
a true random number generator (TRNG) configured to generate an output seed;
a digital signal generator connected to the TRNG, wherein the digital signal generator includes
a seed slicer to receive the output seed, wherein the seed slicer slices the output seed to generate a plurality of slices of random bits;
a pseudo-random number generator (PNG) controller to receive a first set of slices of the plurality of slices from the seed slicer, wherein the PNG controller controls a bank of PNGs;
a PNG select multiplexer coupled to the PNG controller and the bank of PNGs,
wherein each PNG of the bank of PNGs produces a random output based on a first slice of bits of the first set of slices,
wherein the PNG select multiplexer is configured to transmit the random output from a select PNG of the bank of PNGs selected using a second slice of bits of the first set of slices, and
wherein the PNG controller reinitializes the bank of PNGs and the PNG select multiplexer based on a third slice of bits of the first set of slices; and
an RF front-end to generate a random RF signal based on the random output from the select PNG.

2. The random RF signal generator system of claim 1, wherein the digital signal generator further includes a signal processing controller to receive a second set of slices of the plurality of slices from the seed slicer and is configured to apply signal processing variations to generate a digital signal from the random output.

3. The random RF signal generator system of claim 2, wherein the signal processing controller generates a phase adjustment or an amplitude adjustment to the digital signal generated from the random output transmitted by the PNG select multiplexer using a processing module coupled to the signal processing controller based on a first slice of bits of the second set of slices.

4. The random RF signal generator system of claim 3, wherein the signal processing controller generates a filter tap variation for a filter configured to receive the digital signal from the processing module, the filter tap variation generated by the signal processing controller based on the first slice of bits of the second set of slices.

5. The random RF signal generator system of claim 3, wherein the signal processing controller reinitializes the phase adjustment or the amplitude adjustment from the signal processing controller based on a second slice of bits of the second set of slices.

6. The random RF signal generator system of claim 2, wherein the digital signal generator further includes a hardware controller to receive a third set of slices of the plurality of slices from the seed slicer and is configured to apply at least one hardware adjustment to generate the random RF signal from the digital signal.

7. The random RF signal generator of claim 6, wherein the hardware controller is configured to apply the at least one hardware adjustment to at least one component within the RF front-end based on a first slice of bits of the third set of slices.

8. The random RF signal generator of claim 7, wherein the at least one component within the RF front-end is one or more of a time delay unit, a phase shifter, a programmable attenuator, an RF amplifier, and a switched filter bank.

9. The random RF signal generator of claim 6, wherein the at least one hardware adjustment is one or more of a delay to the digital signal, a phase shift of the digital signal, an attenuation of the digital signal, a drain voltage operation of the digital signal, and a filter applied to the digital signal.

10. The random RF signal generator of claim 6, wherein the hardware controller reinitializes the at least one hardware adjustment from the hardware controller based on a second slice of bits of the third set of slices.

11. A random radio frequency (RF) signal generator system comprising:
a true random number generator (TRNG) configured to generate an output seed;
a digital signal generator connected to the TRNG to receive the output seed, wherein the digital signal generator includes
a seed slicer configured to slice the output seed into a first set of slices of random bits from the output seed, a second set of slices of random bits from the output seed, and a third set of slices of random bits from the output seed,
a pseudo-random number generator (PNG) controller coupled to a bank of PNGs and a PNG select multiplexer, wherein the PNG controller is configured to select a select PNG of the bank of PNGs to generate random output using the PNG select multiplexer for a first number of clock counts based on the first set of slices from the seed slicer,
a signal processing controller coupled to a processing module and a filter to generate a digital signal from the random output, wherein the signal processing controller is configured to apply a phase adjustment or an amplitude adjustment to the digital signal for a second number of clock counts based on the second set of slices from the seed slicer, and
a hardware controller coupled to at least one hardware component to generate a random signal from the digital signal, wherein the hardware controller is configured to apply at least one hardware adjustment to the at least one hardware component for a third number of clock counts based on the third set of slices from the seed slicer; and
an RF front-end having the at least one hardware component configured to generate a random RF signal from the digital signal according to the at least one hardware adjustment.

12. The random RF signal generator of claim 11, wherein the PNG controller uses a slice of bits of the first set of slices to seed the select PNG of the bank of PNGs.

13. The random RF signal generator of claim 11, wherein the PNG controller uses a slice of bits of the first set of slices to select the select PNG using the PNG select multiplexer.

14. The random RF signal generator of claim 11, wherein the PNG controller uses a slice of bits of the first set of slices to determine the first number of clock counts.

15. The random RF signal generator of claim 11, wherein the signal processing controller uses a slice of bits from the second set of slices to determine the phase adjustment or the amplitude adjustment from the signal processing controller.

16. The random RF signal generator of claim 11, wherein the signal processing controller uses a slice of bits of the second set of slices to determine the second number of clock counts.

17. The random RF signal generator of claim 11, wherein the hardware controller uses a slice of bits from the third set of slices to determine the at least one hardware adjustment to the at least one hardware component from the hardware controller.

18. The random RF signal generator of claim 11, wherein the hardware controller uses a slice of bits of the third set of slices to determine the third number of clock counts.

19. A method for generating a random radio frequency (RF) signal using a random RF signal generator, the method comprising:
generating an output seed of random bits from a true random number generator (TRNG);
slicing the output seed into a first set of slices of random bits, a second set of slices of random bits, and a third set of slices of random bits using a seed slicer;
generating a random output using a select pseudo-random number generator (PNG) of a bank of PNGs coupled to a PNG controller using a PNG select multiplexer based on the first set of slices from the seed slicer;
generating a digital signal from the random output from the select PNG;
adjusting the digital signal using a phase adjustment or an amplitude adjustment from a signal processing controller based on the second set of slices from the seed slicer;
applying at least one hardware adjustment to the digital signal using at least one hardware component, wherein the at least one hardware adjustment is applied using a hardware controller based on the third set of slices from the seed slicer; and
generating the random RF signal based on the digital signal using an RF front-end having the at least one hardware component.

20. The method of claim 19, wherein generating the random output includes generating the random output for a number of clock counts based on the first set of slices.
